(19) United States
(12) Patent Application Publication
(10) Pub. No.: US 2009/0301594 A1
(43) Pub. Date: Dec. 10, 2009

(54) PIPE FITTING

(76) Inventors: Dirk Raudies, Elsoff (DE); Graeme Bulmer, Tyne & Wear (GB)

Correspondence Address: KLARQUIST SPARKMAN, LLP, 121 SW SALMON STREET, SUITE 1600, PORTLAND, OR, 97204, US

(21) Appl. No.: 12/279,981

(22) PCT Filed: Feb. 16, 2007
(86) PCT No.: PCT/GB2007/000554

§ 371 Date: Dec. 23, 2008

(30) Foreign Application Priority Data
Feb. 24, 2006 (GB) 0603743.6

(51) Int. Cl. F16L 11/00; F16L 11/20

(52) U.S. Cl. 138/126; 138/137; 264/209.7

(57) ABSTRACT

An apparatus and method are disclosed relating to a multi-layer flexible pipe for conveying a target fluid. The pipe includes a core layer arranged to provide an inner bore along which a fluid can flow and at least one barrier layer having a tensile elongation at yield of greater than 5% at a temperature of 23° C.

The present invention relates to a multi-layer flexible pipe of the type for conveying oil or gas or other such fluid. In particular, but not exclusively, the present invention provides such a flexible pipe and discloses materials and a method for manufacturing such a flexible pipe which has a desirable temperature resistance and which has a desirable flexibility.

There are different types of submarine pipes. These are pipes which may be sunk under great depths of sea and which can be used to convey crude oil or gas or some other such fluid from a collection point to a delivery point. It will be understood that such pipes are also applicable to overland and shallow water applications. It is well known that in the art these types of pipes are divided into two broad classes, namely rigid pipes and flexible pipes. The former are normally made of steel and may sometimes be coated in concrete. They are capable of being laid in very deep water. Flexible pipes are normally made up of a number of layers of composites and reinforcing materials such as steel braids. Since the walls of such flexible pipes are made up of a number of interacting layers those walls tend to be thick.

In such a typical and well known “flexible pipe” fluid to be conveyed flows down a central bore which is formed by a core layer which is often referred to as a carcass. An inner surface of this core layer determines the bore whilst an outer surface must be made impervious to penetration by the fluid flowing in the bore. A bore-fluid retaining layer is thus formed at the outer surface of the carcass. This forms a barrier polymer layer which helps prevent oil or gas escaping from the central bore. The layer also prevents ingress of fluid which may otherwise contaminate the bore-fluid. Other layers are formed outwardly in the multi-layer flexible pipe. For example a set of layers of reinforcement wires and an external protection sheath.

One problem associated with flexible pipes of this type is that they are required to flex. This permits the pipe to be laid using a rolling process and also permits the pipe to flex under conditions on site without failure. A particular problem posed by this is that the materials forming each of the layers in such a flexible pipe must be selected so as to produce a desired level of flexibility and also longevity. Flexible pipes thus need a temperature resistance so that they can perform for periods of time over twenty years and in some instances over twenty five years. Also the flexible pipes must have a high chemical resistance so that they can continue to function without chemically degrading as they age.

The degree of flexibility of flexible pipes is determined by the flexibility of the various materials forming the various layers in the multi-layer structure. For layers such as the barrier polymer layer which forms a fluid barrier and which are often formed from thermoplastic materials a statistic which determines the flexibility of that layer and thus of the pipe is the elongation at yield. If the elongation at yield of a thermoplastic layer is too low then when the flexible pipe is flexed the polymers in the layer may be strained beyond their elastic limit which will cause permanent deformation and thus failure of a pipe. It is known that there has been a trade off between temperature resistance and desirable elongation at yield statistic.

It is an aim of embodiments of the present invention to at least partly mitigate the above-mentioned problems.

It is an aim of embodiments of the present invention to provide a flexible pipe which can operate continuously for twenty or more years at temperatures over 150° C.

It is an aim of embodiments of the present invention to provide a flexible pipe which has an elongation at yield of greater than 5% at 23° C.

It is an aim of embodiments of the present invention to provide a flexible pipe which has both a favourable elongation at yield characteristic as well as a high temperature resistance.

It is an aim of embodiments of the present invention to provide a method for producing such a flexible pipe.

In accordance with a first aspect of the present invention there is provided a multi-layer flexible pipe for conveying a target fluid, comprising:
a core layer arranged to provide an inner bore along which a fluid can flow; and
a least one barrier polymer layer having a tensile elongation at yield of greater than 5% at a temperature of 23° C.

In accordance with a second aspect of the present invention there is provided a multi-layer flexible pipe for conveying a target fluid, comprising:
a core layer arranged to provide an inner bore along which a fluid can flow; and
at least one barrier polymer layer for withstanding temperatures greater than 150° C. continuously for more than twenty years.

In accordance with a third aspect of the present invention there is provided a method for providing a multi-layer flexible pipe for conveying a target fluid comprising the steps of:
providing a core layer having an inner bore along which a target fluid can flow; and
providing at least one barrier polymer layer having a tensile elongation at yield of greater than 5% at a temperature of 23° C.

In accordance with a fourth aspect of the present invention there is provided a method for providing a multi-layer flexible pipe for conveying a target fluid comprising:
providing a core layer having an inner bore along which a target fluid can flow; and
providing at least one barrier polymer layer for withstanding temperatures greater than 150° C. continuously for greater than twenty years.

Embodiments of the present invention provide a multi-layer flexible pipe which includes as a barrier layer, or as part of a fluid barrier layer, a polymer layer having a tensile elongation at yield of greater than 5% at a temperature of 23° C. This ensures that the flexible pipe will be flexible enough to be located at a desired location and to perform adequately at that location for extended periods of time.

Embodiments of the present invention provide a flexible pipe which includes a fluid barrier layer or part of a fluid barrier layer which is able to withstand temperatures greater than 150° C. continuously for extended periods of time.

Embodiments of the present invention will now be described hereinafter, by way of example only, with reference to the accompanying drawings, in which:

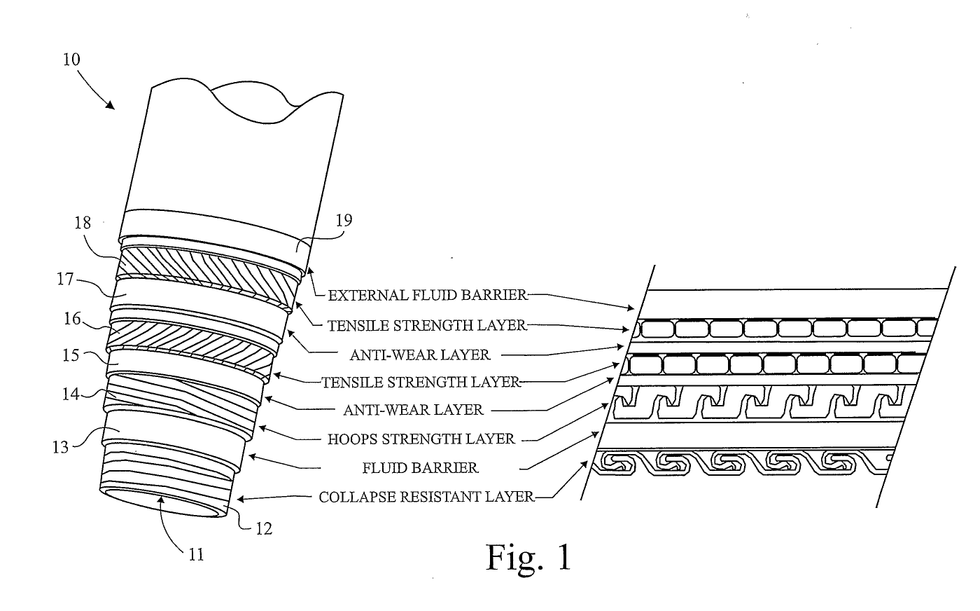

FIG. 1 illustrates a cross section through a multi-layer flexible pipe;

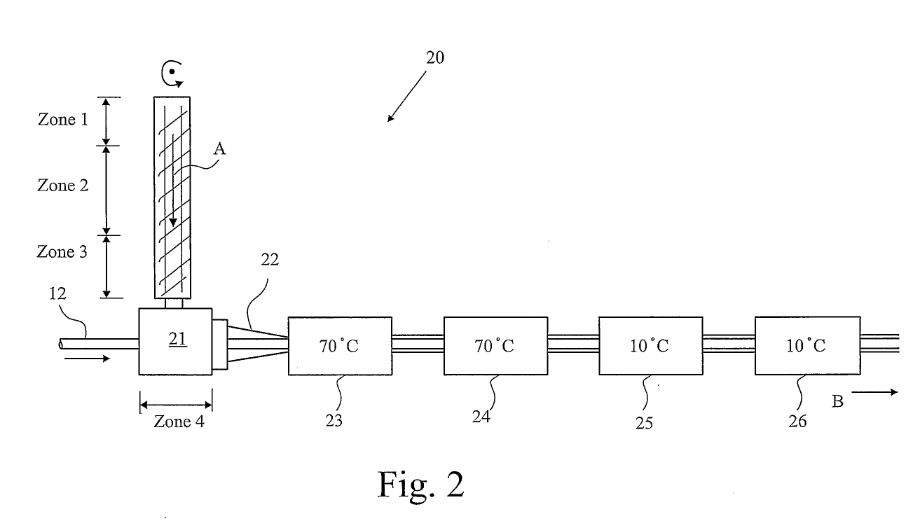

FIG. 2 illustrates an extrusion station with cooling baths; and

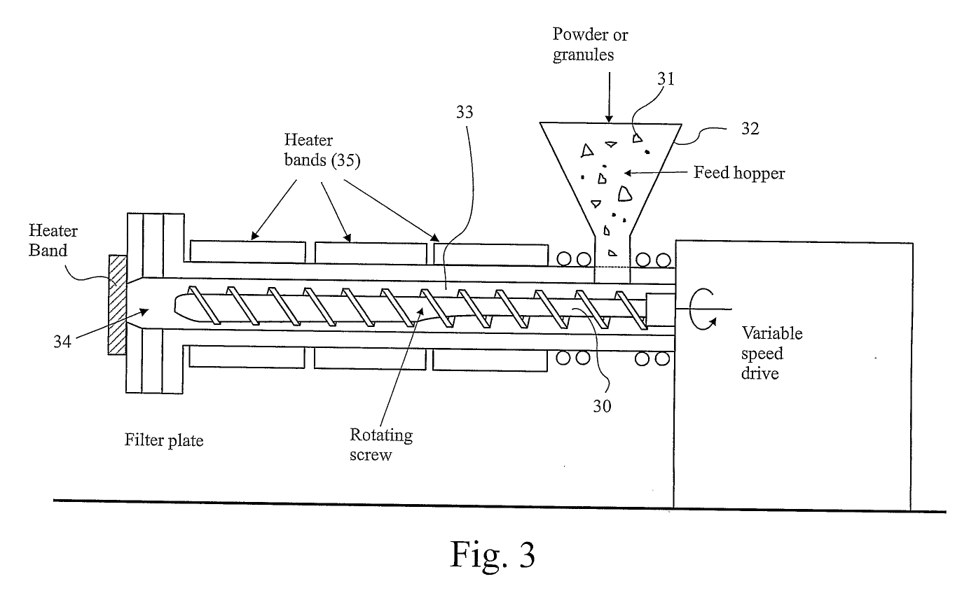

FIG. 3 illustrates another view of an extrusion station.

In the drawings like reference numerals refer to like parts.

FIG. 1 illustrates a cutaway image of a flexible pipe 10 according to an embodiment of the present invention. The flexible pipe 10 is a multi-layer pipe which may be used, amongst other purposes, for conveying a fluid such as crude oil export oil or a gas. Such fluids may be referred to as typical oil and gas field fluids. Each layer of the multi-layer flexible pipe is able to move with respect to the next layer. It will be understood however that embodiments of the present invention are not restricted to any specific number of multi-layers nor to the fact that one or more of the layers may be bonded to another layer.

Fluid flows through an internal bore 11 which is formed by the inner surface of a central core layer commonly known as a carcass 12. This forms a collapse resistant layer. The core layer is formed from folded wire as is known in the art which may be permeable to fluid either outwardly from the bore or inwardly from the outside of the pipe to the inside. Such flow may either contaminate bore fluid or cause other problems such as loss of bore fluid. A fluid barrier layer 13 is formed in the outside of the collapse resistant layer. This is formed from a thermoplastic material and thus forms a barrier polymer layer. The barrier polymer layer may be formed from one of many varieties of polyphenylenesulfide (PPS) layers. This may either be a neat PPS polymer, and/or a PPS modified with conventional additives such as stabilizers, lubricants, mold release agents, colorants, pigments, nucleating agents, reinforcing agents, and fillers, such as fibrous fillers including glass fibres, and/or a blend of PPS with another polymer, including but not limited to a blend of PPS with a flexibilising component, such as an elastomer and/or a copolymer of PPS.

A hoop strength layer 14 is formed outside the fluid barrier layer and then an anti-wear layer 15 is formed. Outside the anti-wear layer is a first tensile strength layer 16 formed from wires wound in a particular direction. A further anti-wear layer 17 is then provided followed by a second tensile strength layer. An outer external fluid barrier layer 19 is formed which prevents ingress of fluid from the external surroundings of the pipe into any of the inner layers.

FIG. 2 illustrates an extrusion station 20 forming part of a manufacturing process for forming the flexible pipe as shown in FIG. 1. It will be understood that the manufacturing process includes many different stations each of which may be used to apply one or more of the layers shown in FIG. 1 as selected. An initial core layer 12 is rolled into an extrusion chamber 21 which is heated via one or more heaters to an appropriate temperature in the range of 300° C. to 330° C. Preferably at 305° C. The core layer is a metal layer formed from interlink wires as is known in the art. Molten thermoplastic material is directed into the extrusion chamber 21 along a path indicated by arrow A in FIG. 2. This movement is achieved by driving a central rotating screw within an outer casing. This is illustrated more clearly in FIG. 3 in which the rotating screw 30, which has a variable diameter, is driven at a variable and selectable speed by a variable speed motor (not shown). Powder or granules 31 of the polymer material which will form the barrier polymer layer are loaded into a feed hopper 32. These granules fall into a central bore region 33 and are directed towards the extruding chamber 34 by the rotating motion of the screw 30. One or more heating bands 35 (or zones) are located around the extrusion station. Heaters are placed around the extrusion path and chamber to generate a desired temperature gradient from the relatively cold end close to the hopper to the heated end by the extrusion chamber. Heaters in the first heater band can generate temperatures in the range 285° C. to 325° C. Preferably at 300° C. Heaters in second heater band can generate temperatures in the region of 300° C. to 330° C. Preferably 310° C. Heaters in the third heater band closest to the extrusion chamber generate temperatures in the range 310° C. to 335° C. Preferably 315° C. In this way the powder or granules fed into the hopper will be molten and at a desired viscosity in the extrusion chamber 34 within the extruding chamber 20. As the pipe 12 is passed through this chamber in a direction out of the neck region in FIG. 3 molten thermoplastic material forms a layer on the outside of the piping. To aid the process the core layer may be heated by heaters prior to its entry into the extrusion chamber. Preferably the core layer temperature may be set to between 30° C. to 40° C. By selecting the dimensions of a narrowing region 22 the thickness of the barrier polymer layer formed during the extrusion process may be selected. Other methods for selecting the thickness may be used, for example by varying the speed of delivery and extraction of the core layer. By selecting the profile of the narrowing neck so as to narrow to an opening only just admitting the pipe a thin layer of barrier polymer layer can be generated. If the neck is not narrowed so much then a thicker layer of barrier polymer layer is developed.

A neat PPS, a modified PPS), or a blend of PPS with another polymer are suitable thermoplastic materials for forming a flexible pipe having desired characteristics according to embodiments of the present invention. PPS is a high-temperature thermoplastic material that offers an excellent combination of thermal mechanical and chemical resistance. By introducing a flexibilising component to PPS a multi-layer flexible pipe can be provided which has high temperature resistance and which satisfies desirable flexibleness. The PPS used preferably is a blend of PPS with a flexibilising component, such as an elastomer. In particular, a barrier polymer layer designed to withstand temperatures greater than 150° C. continuously for more than twenty years can be provided. Embodiments of the present invention can provide a barrier polymer layer designed to withstand temperatures greater than 200° C. continuously for more than twenty five years. In addition the barrier polymer layer so formed has a tensile elongation at yield of greater than 5% at a temperature of 23° C. Embodiments of the present invention provide a barrier polymer layer that has a tensile elongation at yield of greater than 7% at a temperature of 23° C.

Preferably an embodiment of the present invention uses an example of a PPS blended with a flexibilising component. One such material is the commercially available Fortron® SKX-479 available from Ticona GmbH, Kelsterbach, Germany. Alternatively Fortron FX 4372T6 may be used. It is to be understood that the present invention is not limited to the use of only these two named products. Rather the invention is broadly applicable to the use of materials having one or more characteristic features shared with these materials.

As illustrated in FIG. 2 a number of cooling baths may be used to cool the barrier polymer layer so as to achieve an agreeable end product. An initial cooling node 23 maintains a temperature of between 70° C. and 80° C. The pipe passes through this zone for a number of seconds as it is rolled in a motion indicated by arrow B in FIG. 2. A further cooling bath 24, is arranged to also maintain a temperature of between 70° C. and 80° C., may also be used as may still further baths 25 and 26 which are set at around 15° C.

By raising the temperature of the flexibilised PPS in its granular form to above its melting point and then re-forming and cooling the PPS with flexibilising components into the shape of a continuous hollow profile a barrier layer around the carcass can be formed. It will be appreciated that the temperature settings may be adjusted and controlled according to predetermined selected ranges so as to control temperatures in both the heating and cooling zones of the extrusion station.

Embodiments of the present invention have been described hereinabove by way of example only. It will be understood that the present invention is not restricted to the specific details of the embodiments described. For example the flexible pipe may include only a core layer and barrier polymer layer. At least one tensile strength layer and at least one external fluid barrier layer may be also provided. Embodiments of the present invention provide a multi-layer non-bonded flexible pipe for conveying oil and gas field fluids.

Whilst the fluid barrier layer has been described as a single layer the fluid barrier layer 13 may in fact itself by formed as a multi-layer structure with only one or more of these layers being formed from the modified PPS as hereinabove described. Other layers in such a multi-layer barrier layer may be selected from the list of HDPE, MDPE, PP, PA-11, PA-12, TPE and/or PVDF.

Also it will be understood that embodiments of the present invention are not restricted to undersea pipe types. Rather the present invention may be applied in any pipe application where temperature resistance, chemical resistance and flexibility are desirable characteristics.

1. A multi-layer flexible pipe for conveying a target fluid, comprising:
a core layer arranged to provide an inner bore along which a fluid can flow; and
a least one barrier layer having a tensile elongation at yield of greater than 5% at a temperature of 23° C.

2. The flexible pipe as claimed in claim 1 wherein said barrier layer provides a flexible pipe for withstanding temperatures greater than 150° C. continuously for more than twenty years.

3. A multi-layer flexible pipe for conveying a target fluid, comprising:
a core layer arranged to provide an inner bore along which a fluid can flow; and
at least one barrier layer for withstanding temperatures greater than 150° C. continuously for more than twenty years.

4. The flexible pipe as claimed in claim 3 wherein the barrier layer has a tensile elongation at yield of greater than 5% at a temperature of 23° C.

5. The flexible pipe as claimed in claim 1 wherein the barrier layer has an elongation at yield of at least 7% at a temperature of 23° C.

6. The flexible pipe as claimed in claim 1 wherein said barrier layer is an extruded layer.

7. The flexible pipe as claimed in claim 1 wherein said barrier layer comprises polyphenylenesulfide (PPS).

8. The flexible pipe as claimed in claim 7 wherein said barrier layer comprises a blend of PPS with a flexibilising component.

9. The flexible pipe as claimed in claim 8 wherein said flexibilising component is an elastomer.

10. The flexible pipe as claimed in claim 1 wherein said barrier layer comprises a copolymer of PPS.

11. The flexible pipe as claimed in claim 1 wherein said barrier layer comprises a PPS and/or copolymer of PPS that is modified with conventional additives.

12. The flexible pipe as claimed in claim 1 wherein said barrier layer comprises a barrier polymer layer.

13. The flexible pipe as claimed in claim 1 wherein said target fluid comprises crude oil.

14. The flexible pipe as claimed in claim 1 wherein said target fluid comprises a gas.

15. The flexible pipe as claimed in claim 1 wherein said target fluid comprises export oil.

16. The flexible pipe as claimed in claim 1 wherein said barrier layer comprises a bore-fluid retaining layer.

17. The flexible pipe as claimed in claim 1 wherein said barrier layer directly surrounds the core layer.

18. The flexible pipe as claimed in claim 1 wherein said multi-layer flexible pipe has three or more layers.

19. The flexible pipe as claimed in claim 1 wherein said barrier layer is disposed in a spaced apart relationship from said core layer.

20. The flexible pipe as claimed in claim 19 wherein one or more intermediate layers are located between said core layer and said barrier layer.

21. The flexible pipe as claimed in claim 1 wherein said barrier layer has a high creep resistance.

22. A flexible pipe as claimed in claim 1 wherein said barrier layer provides a layer with a high chemical resistance.

23. A flexible pipe as claimed in claim 1 wherein said flexible pipe comprises a non-bonded flexible pipe.

24. A flexible pipe as claimed in claim 1 wherein said core layer comprises a collapse-resistant layer.

25. A flexible pipe as claimed in claim 1 wherein said barrier layer comprises a fluid barrier layer.

26. The flexible pipe as claimed in claim 1 further comprising: at least one tensile strength layer; and at least one external fluid barrier layer.

27. The flexible pipe as claimed in claim 1 wherein the at least one barrier layer is an innermost polymer extruded layer located beneath a hoop strength layer.

28. The flexible pipe as claimed in claim 1 wherein said barrier layer comprises one layer of a multi-layer barrier layer.

29. The flexible pipe as claimed in claim 28 wherein the multi-layer barrier layer comprises one or more layers of a further barrier material.

30. The flexible pipe as claimed in claim 29 wherein the further barrier material is selected from the list of HDPE, MDPE, PP, PA-I1, PA-12, TPE, and PVDF.

31. The flexible pipe as claimed in claim 1 wherein said barrier layer comprises a polymer having a melting point of more than 150° C.

32. A method for providing a multi-layer flexible pipe for conveying a target fluid comprising the steps of:
providing a core layer having an inner bore along which a target fluid can flow; and
providing at least one barrier layer having a tensile elongation at yield of greater than 5% at a temperature of 23° C.

33. The method as claimed in claim 32 further comprising: providing a multi-layer flexible pipe for withstanding temperatures greater than 150° C. continuously for more than twenty years.

34. A method for providing a multi-layer flexible pipe for conveying a target fluid comprising:
providing a core layer having an inner bore along which a target fluid can flow; and
providing at least one barrier layer for withstanding temperatures greater than 150° C. continuously for greater than twenty years.

35. The method as claimed in claim 34 further comprising:
providing the at least one barrier layer which has a tensile elongation at yield of greater than 5%.

36. The method as claimed in claim 32 wherein the barrier layer comprises a blend of polyphenylenesulfide (PPS).

37. The method as claimed in claim 32 further comprising the steps of:
melting modified PPS in a feed hopper;
providing the melted polymer at an extrusion chamber; and
forming a barrier layer around an inner core layer at an extrusion station.

38. The method as claimed in claim 37 further comprising establishing two or more temperature zones in a melting node to thereby provide molten barrier material at the extrusion chamber.

39. The method as claimed in claim 38 further comprising: providing a plurality of cooling baths to cool the barrier layer on said core layer subsequent to the core layer being passed through the extrusion chamber.

40. The method as claimed in claim 36 wherein said blend of PPS comprises a blend of PPS with a flexibilising agent.

41. The method as claimed in claim 32 wherein said barrier layer comprises a barrier polymer layer.

42. (canceled)

43. (canceled)
